(19) United States
(12) Patent Application Publication
(10) Pub. No.: US 2026/0056580 A1
(43) Pub. Date: Feb. 26, 2026

(54) COMPUTING DEVICE WITH EXTENDABLE DISPLAY AND EXTENDABLE HUMAN INPUT DEVICE CARRIER

(71) Applicant: Lenovo (United States) Inc., Morrisville, NC (US)

(72) Inventors: Aryan Thaman, Troy, MI (US); Daniel C Chisu, Mundelein, IL (US)

(21) Appl. No.: 19/373,287

(22) Filed: Oct. 29, 2025

Related U.S. Application Data
(63) Continuation of application No. 29/923,058, filed on Dec. 27, 2023, now Pat. No. D1103164.

(51) Int. Cl. G06F 1/16

(52) U.S. Cl. CPC G06F 1/1641; G06F 1/1616; G06F 1/1624; G06F 1/1647; G06F 1/1652; G06F 1/1681

(57) ABSTRACT

A computing device can include a base housing; a foldable display; a display housing for the foldable display where the foldable display includes an open unfolded position, a closed folded position, and an open tented position; and one or more hinge assemblies that couple the base housing and the display housing.

### RELATED APPLICATIONS

This application is a continuation of a co-pending U.S. Design Patent Application having Ser. No. 29/923,058, filed 27 Dec. 2023, which is incorporated by reference herein.

### DESIGN NOTICE

We, Aryan Thaman and Daniel C. Chisu, have invented a new, original, and ornamental design for a computing device with extendable display and extendable human input device carrier of which the following is a specification, reference being had to the accompanying drawings, forming a part thereof.

### BACKGROUND

A computing device may include a base housing and a display housing that may be coupled by one or more hinge assemblies to provide for opening and closing the housings.

### SUMMARY

A computing device can include a base housing; a foldable display; a display housing for the foldable display where the foldable display includes an open unfolded position, a closed folded position, and an open tented position; and one or more hinge assemblies that couple the base housing and the display housing.

### BRIEF DESCRIPTION OF THE DRAWINGS

FIG. 1 is a perspective view of a computing device with extendable display and extendable human input device carrier in an open position showing our design;

FIG. 2 is a front view thereof in an open position;

FIG. 3 is a back view thereof in an open position;

FIG. 4 is a side view thereof in an open position;

FIG. 5 is a side view thereof in an open position;

FIG. 6 is a top view thereof in an open position;

FIG. 7 is a bottom view thereof in an open position;

FIG. 8 is a front view thereof in an open position and in an extended position of an extendable human input device carrier;

FIG. 9 is a side view thereof in an open position and in an extended position of an extendable human input device carrier where the other side is identical or a mirror image;

FIG. 10 is a top view thereof in an open position and in an extended position of an extendable human input device carrier;

FIG. 11 is a bottom view thereof in an open position and in an extended position of an extendable human input device carrier;

FIG. 12 is a perspective view thereof in a closed position;

FIG. 13 is a top view thereof in a closed position;

FIG. 14 is a front view thereof in a closed position;

FIG. 15 is a back view thereof in a closed position;

FIG. 16 is a side view thereof in a closed position where the other side is identical or a mirror image;

FIG. 17 is a perspective view thereof in an open position and in a non-extended position of an extendable display;

FIG. 18 is a perspective view thereof in an open position and in a first extended position of an extendable display;

FIG. 19 is a perspective view thereof in an open position and in a second extended position of an extendable display;

FIG. 20 is a perspective view thereof in an open position and in a first extended position of an extendable human input device carrier that exposes an auxiliary display;

FIG. 21 is a perspective view thereof in an open position and in a second extended position of an extendable human input device carrier that exposes an auxiliary display;

FIG. 22 is a perspective view thereof in an open position and in an extended position of an extendable human input device carrier that exposes an auxiliary display and that carries a keyboard;

FIG. 23 is a perspective view thereof in an open position and in an extended position of an extendable human input device carrier that exposes an auxiliary display and that carries a human input touch surface;

FIG. 24 is a perspective view thereof in an open position and in an extended position of an extendable human input device carrier that exposes an auxiliary display and that carries a displayable human input device;

FIG. 25 is a perspective view thereof in an open position and in an extended position of an extendable human input device carrier that exposes an auxiliary display;

FIG. 26 is a perspective view thereof in an open position and in a partially extended position of an extendable display;

FIG. 27 is a perspective view thereof in an open position and in a partially extended position of an extendable display;

FIG. 28 is a perspective view thereof in an open position and in a partially extended position of an extendable display;

FIG. 29 is a perspective view thereof in a closed position;

FIG. 30 is a top view thereof in a closed position where the bottom is identical or a mirror image;

FIG. 31 is a front view thereof in a closed position;

FIG. 32 is a back view thereof in a closed position;

FIG. 33 is a side view thereof in a closed position where the other side is identical or a mirror image;

FIG. 34 is a perspective view thereof in an open position and in a non-extended position of an extendable display;

FIG. 35 is a perspective view thereof in a closed position;

FIG. 36 is a side view thereof in a closed position where the other side is identical or a mirror image;

FIG. 37 is a top view thereof in a closed position where the bottom is identical or a mirror image;

FIG. 38 is a perspective view thereof in an open position and in an extended position of an extendable display;

FIG. 39 is a front view thereof in an open position and in an extended position of an extendable display;

FIG. 40 is a back view thereof in an open position and in an extended position of an extendable display;

FIG. 41 is a side view thereof in an open position and in an extended position of an extendable display;

FIG. 42 is a side view thereof in an open position and in an extended position of an extendable display;

FIG. 43 is a top view thereof in an open position and in an extended position of an extendable display;

FIG. 44 is a bottom view thereof in an open position and in an extended position of an extendable display;

FIG. 45 is a perspective view thereof in an open position and in a tented position of an extendable display;

FIG. 46 is a front view thereof in an open position and in a tented position of an extendable display;

FIG. 47 is a back view thereof in an open position and in a tented position of an extendable display;

FIG. 48 is a side view thereof in an open position and in a tented position of an extendable display where the other side is identical or a mirror image;

FIG. 49 is a top view thereof in an open position and in a tented position of an extendable display;

FIG. 50 is a side view thereof in an open position and in a folded position of an extendable display;

FIG. 51 is a perspective view thereof in a closed position and in a viewable position of a portion of an extendable display;

FIG. 52 is a front view thereof in a closed position and in an exposed, viewable position of a portion of an extendable display;

FIG. 53 is a back view thereof in a closed position and in an exposed, viewable position of a portion of an extendable display;

FIG. 54 is a side view thereof in a closed position and in an exposed, viewable position of a portion of an extendable display where the other side is identical or a mirror image; and

FIG. 55 is a top view thereof in a closed position and in an exposed, viewable position of a portion of an extendable display.

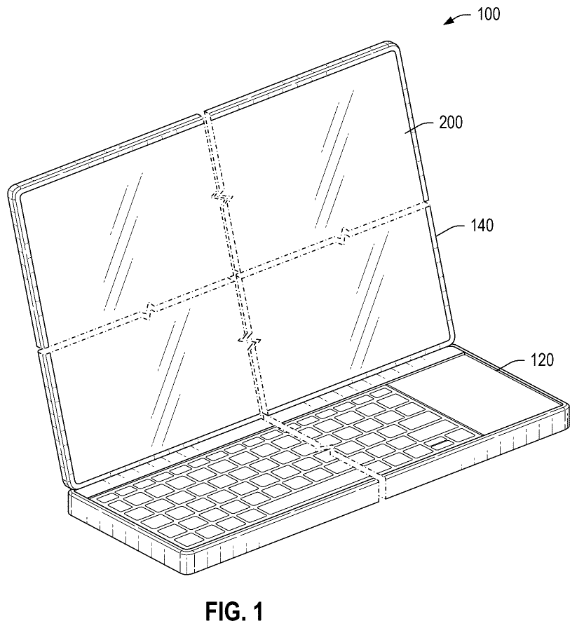

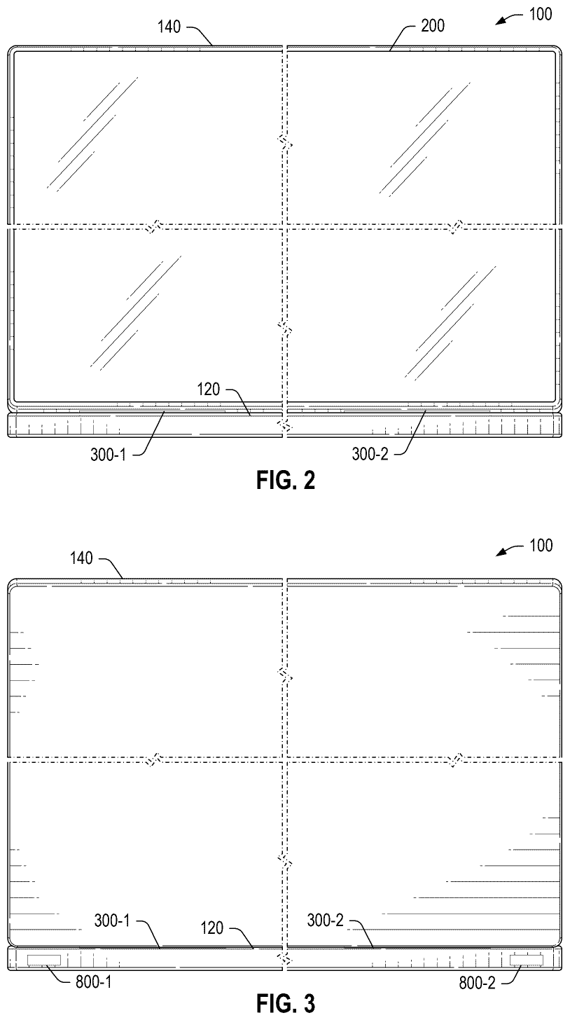

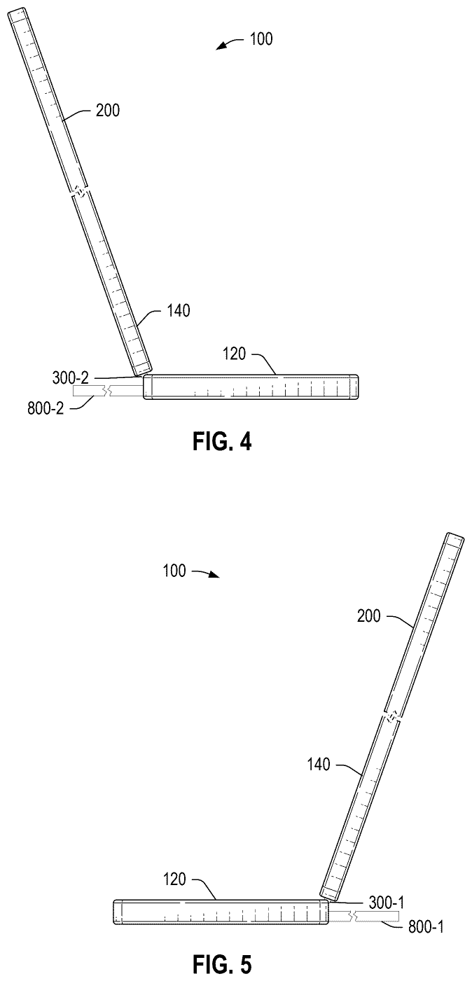

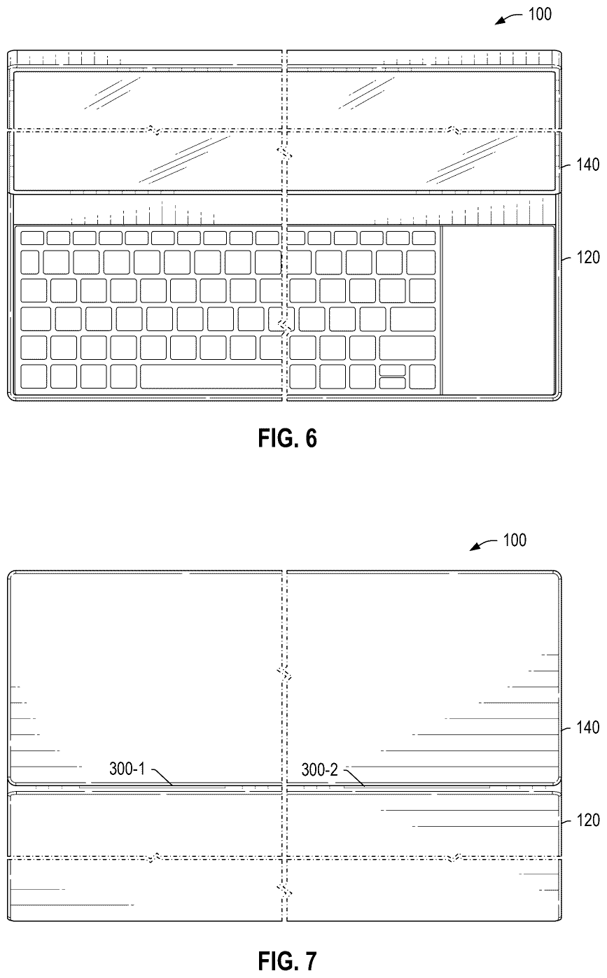

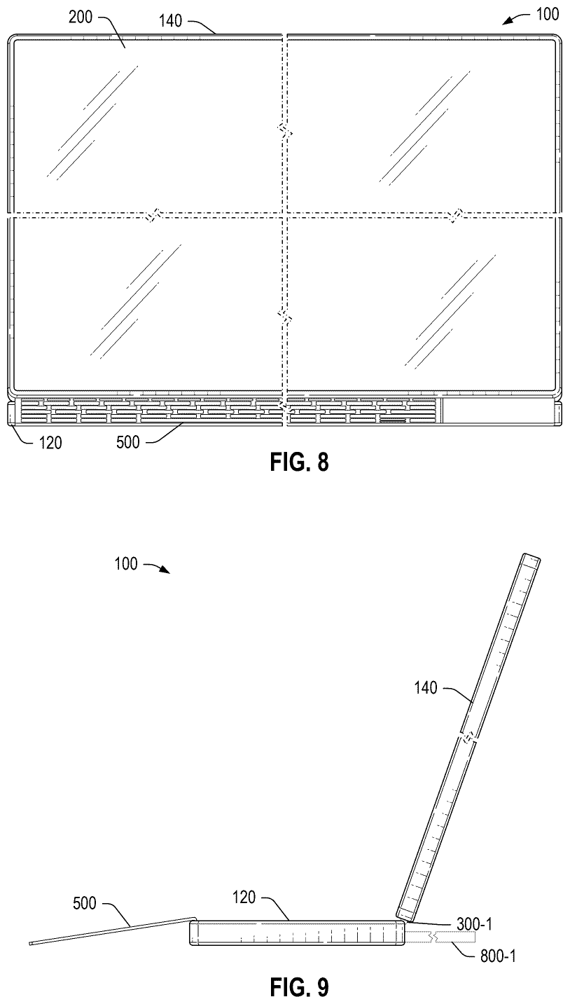

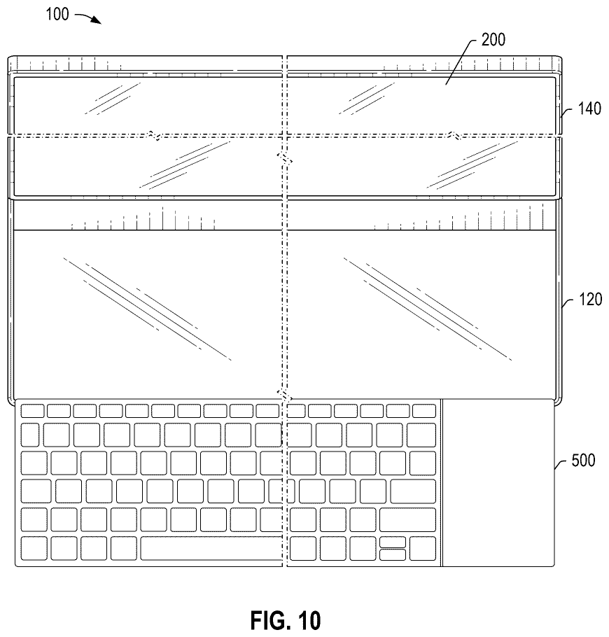

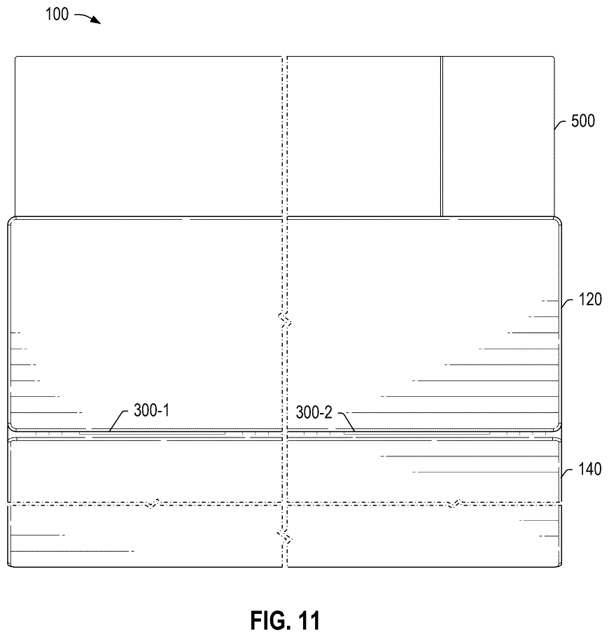

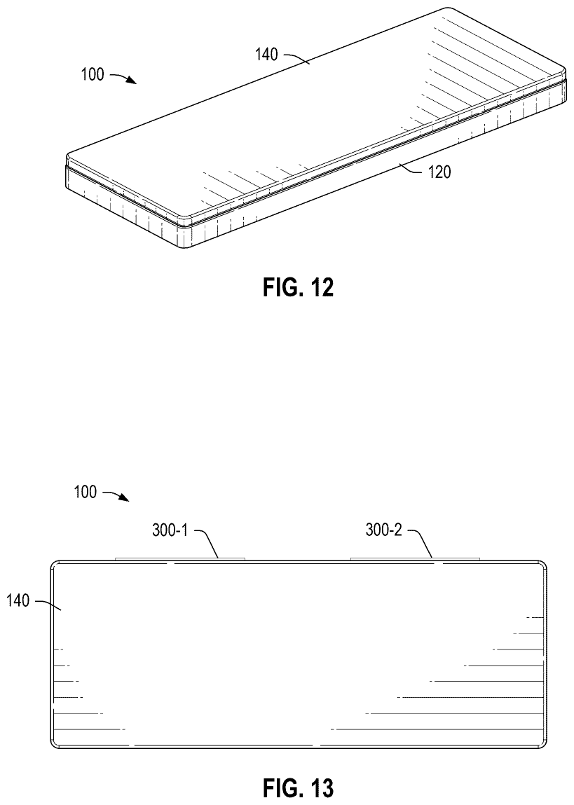

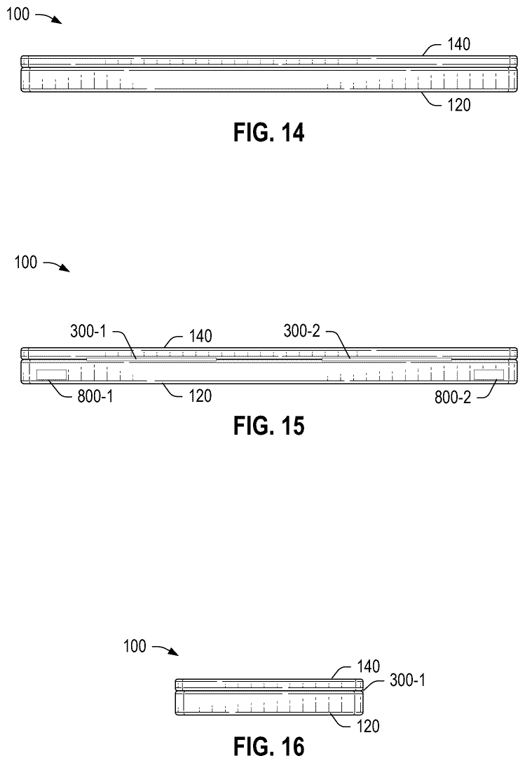

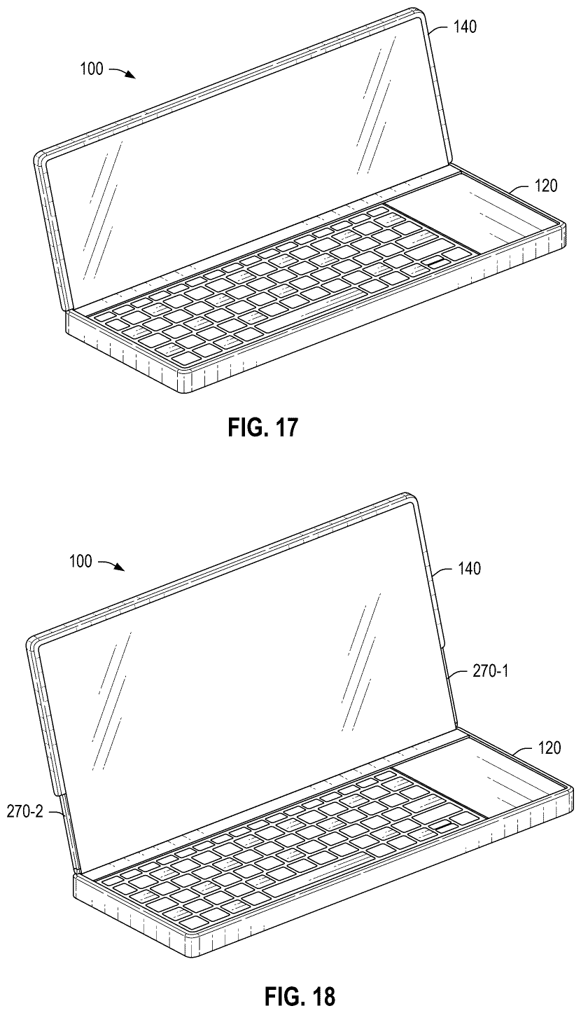

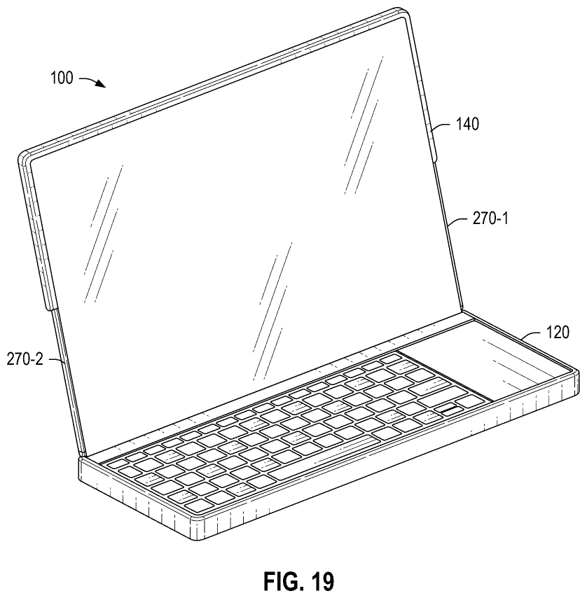

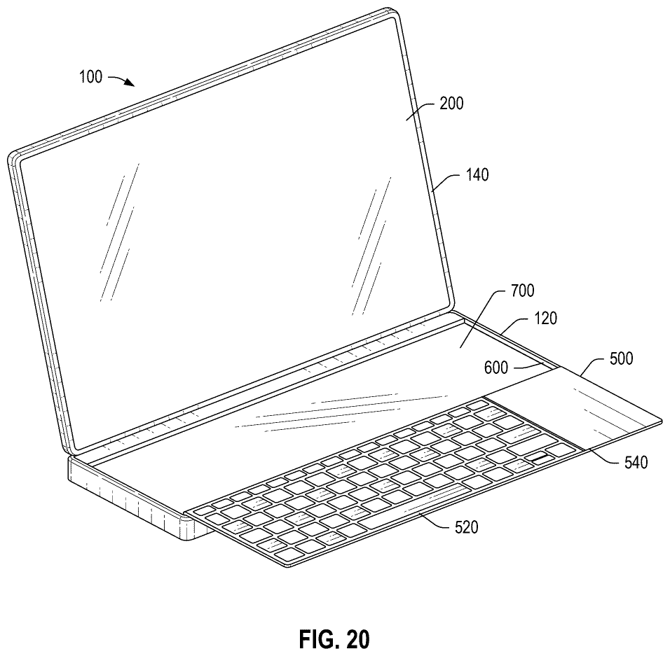

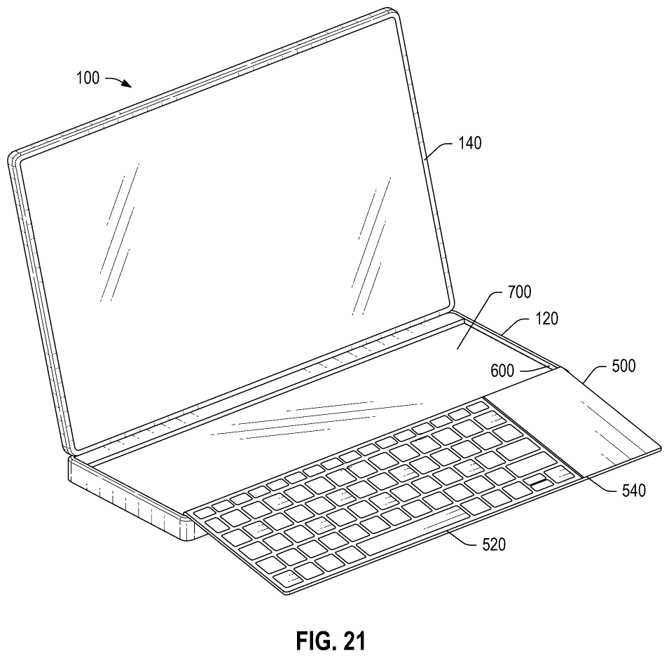

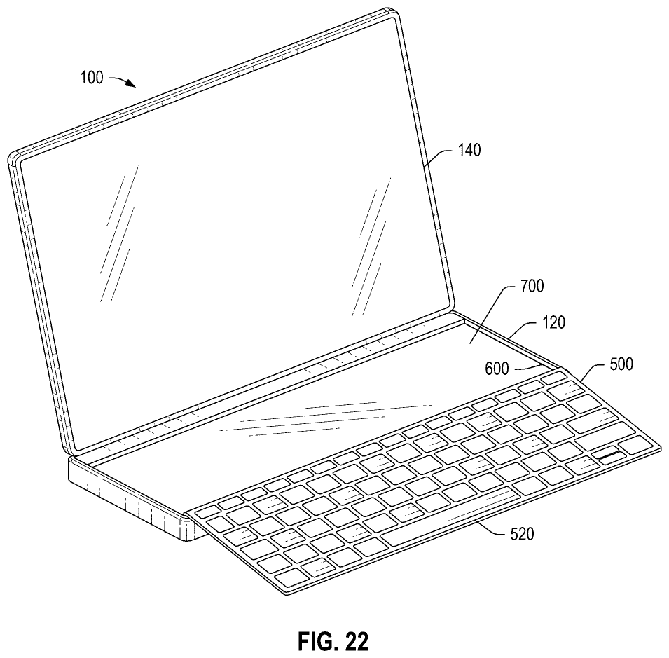

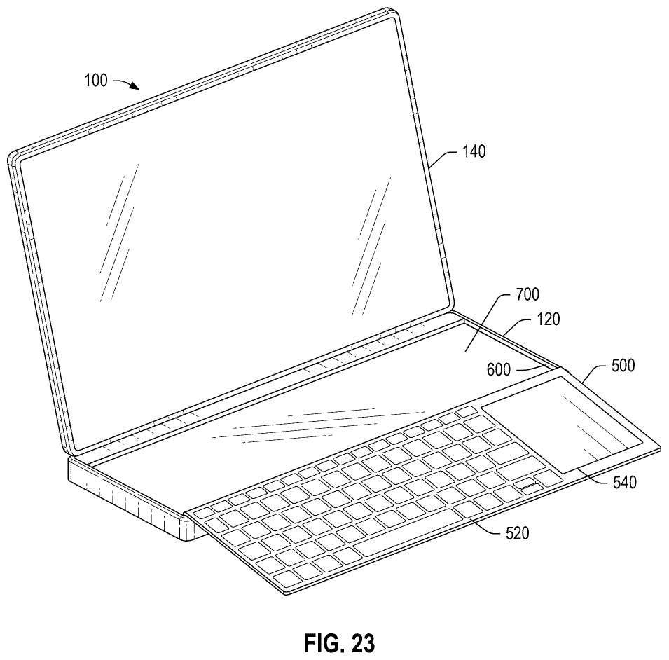

### DETAILED DESCRIPTION

As an example, a computing device 100 can include housings 120 and 140 coupled by one or more hinge assemblies 300-1 and 300-2. As an example, an extendable display 200 of a computing device 100 may be foldable and/or an extendable display may be rollable. As an example, a foldable extendable display may include one or more hinge assemblies 300-3 that provide for folding, which may be in one direction or in multiple directions. As an example, a folded extendable display may include a visible portion 250 when in a folded position, which may be a closed position of a computing device 100. As an example, a rollable extendable display may include a roller that may be disposed at least in part in a housing 120 and a rollable extendable display may include rails 270-1 and 270-2 that may be extendable to guide rolling out and rolling in of the rollable extendable display where the rails 270-1 and 270-2 may be part of another housing 140.

As an example, an extendable human input device carrier 500 of a computing device 100 may be extendable from a housing 120 (e.g., a base housing of a computing device 100). As an example, an extendable human input device carrier 500 may be extendable in a manner guided by channels of a housing and/or rails 600. As an example, an extendable human input device carrier 500 may be slidable and/or tiltable. As an example, an extendable human input device carrier 500 may include a mass that may be extendable for purposes of balance (e.g., as a counterbalance to an extended, extendable display), which may provide for computing device stability. As an example, a housing 120 may include one or more extensions 800-1 and 800-2 (e.g., telescopic extensions) that may be deployed for stability (e.g., to reduce risk of a computing device 100 tipping backwards). As an example, an extendable human input device carrier 500 may carry one or more features and/or components. As an example, a feature and/or a component may be a keyboard 520, a display 550 (e.g., a touch sensitive display), a wireless charging surface of wireless charging circuitry, a touchpad 540, or a digitizer pad.

As an example, a computing device 100 may include associated electronics (e.g., circuitry, which may include one or more processors, memory, one or more batteries, etc.) with a keyboard 520 and a touchpad 540, and a foldable and/or rollable display 200, where the keyboard 520 and the touchpad 560 are carried by or integral with an extendable human input device carrier 500 that may slide out and tilt down. As an example, a display 700 that may be an auxiliary display may be underneath a non-extended extendable human input device carrier 500 such that upon extension of the extendable human input device carrier 500, the display 700 is revealed. As an example, an underlying area of an extendable human input device carrier 500 may include one or more of a touchpad, a digitizer pad, and an auxiliary display, and a wireless charging surface (e.g., for a mobile device). As an example, a computing device 100 may include one or more ports (e.g., for data and/or power) that may include one or more serial ports.

As an example, a computing device 100 with an extendable display 200 and an extendable human input device carrier 500 may be transitionable between various positions, which may include extended and/or non-extended positions, where, for example, an extended position may be a fully extended position or a partially extended position. As an example, a computing device 100 may include circuitry for automatically extending, retracting and/or closing (e.g., consider one or more electric motors that may be operatively coupled to one or more components of a computing device 100). As an example, one or more portions of a computing device 100 may be at least in part automatically transitionable from one position to another position or positions.

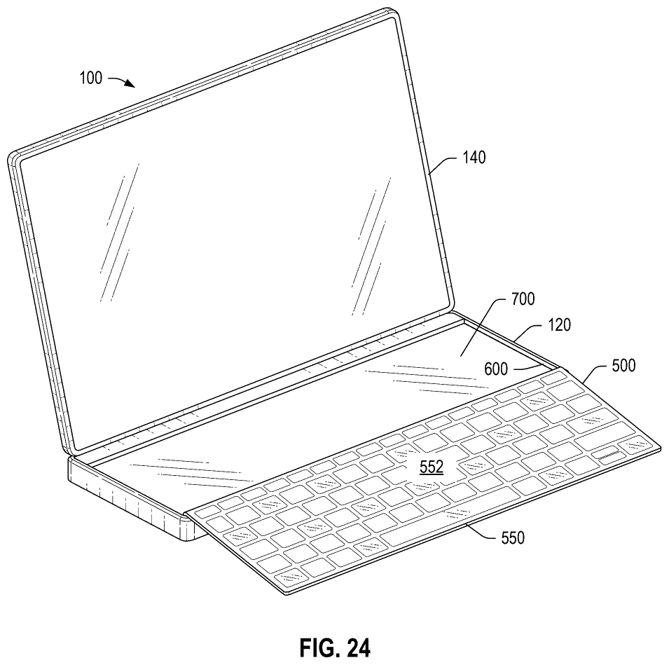

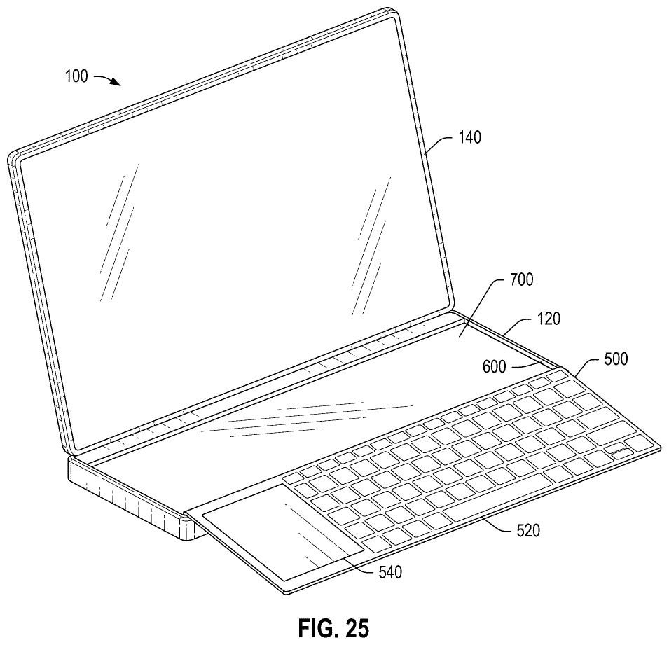

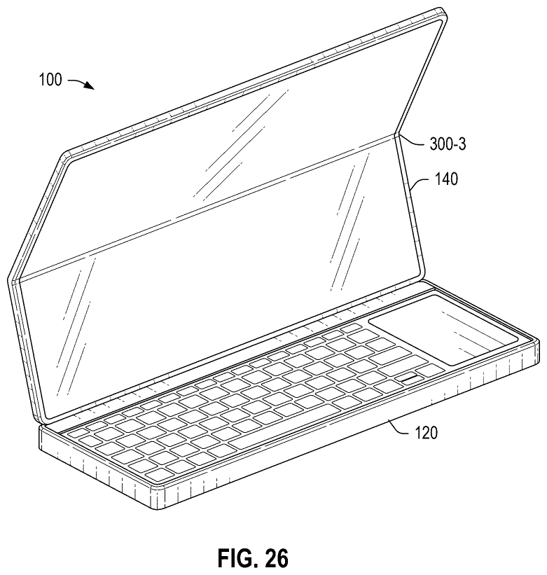

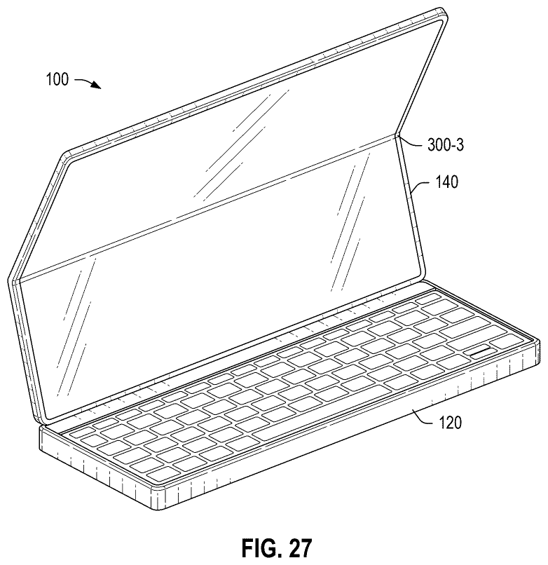

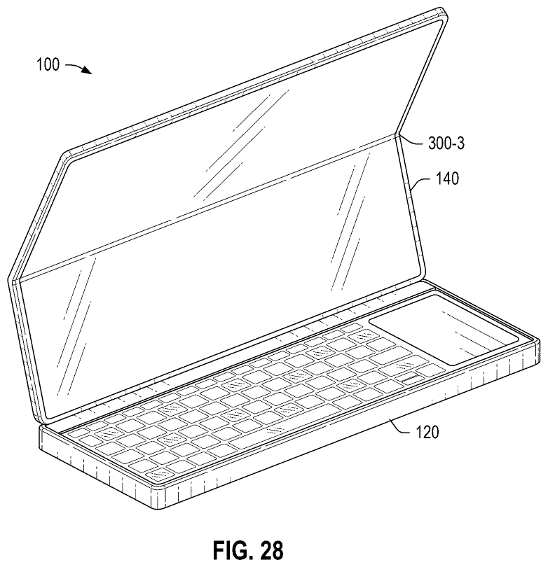

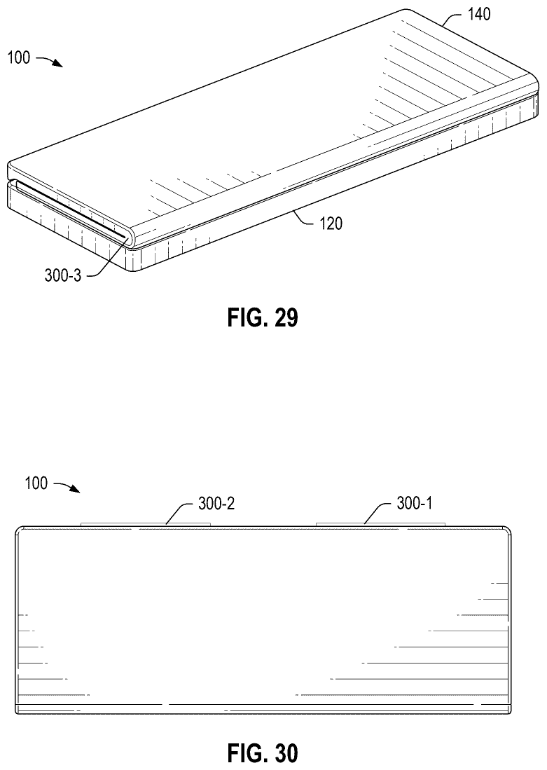

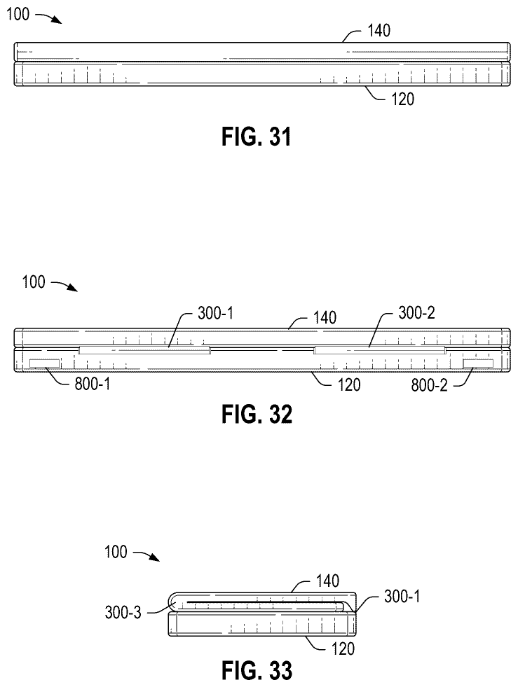

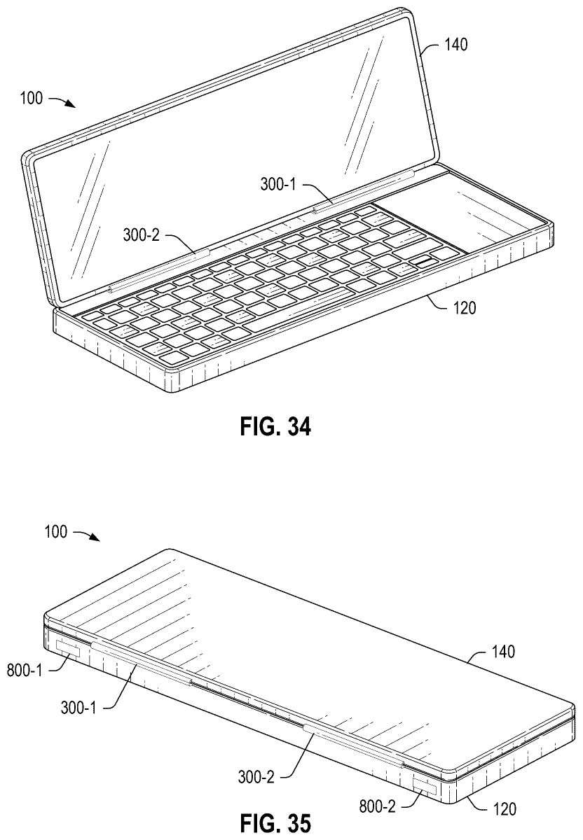

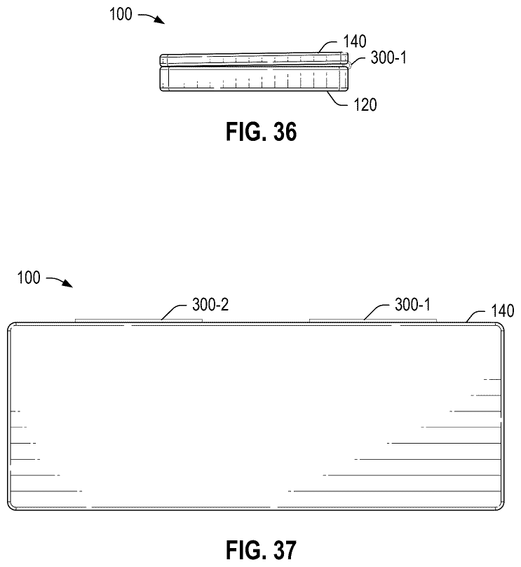

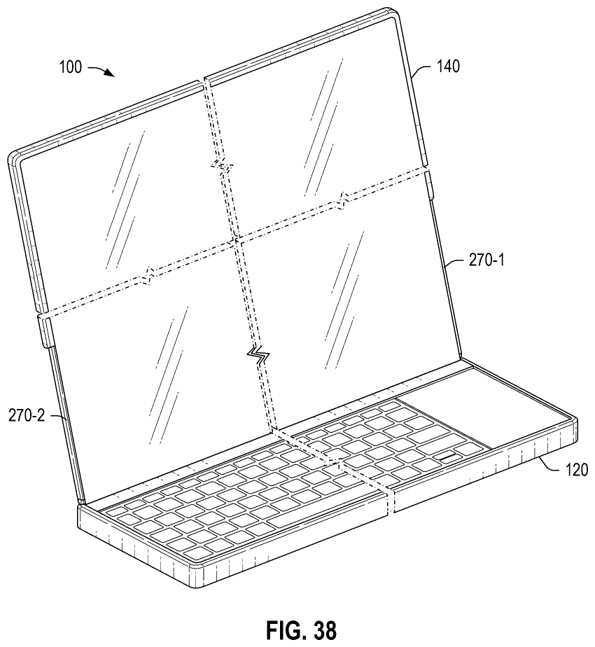

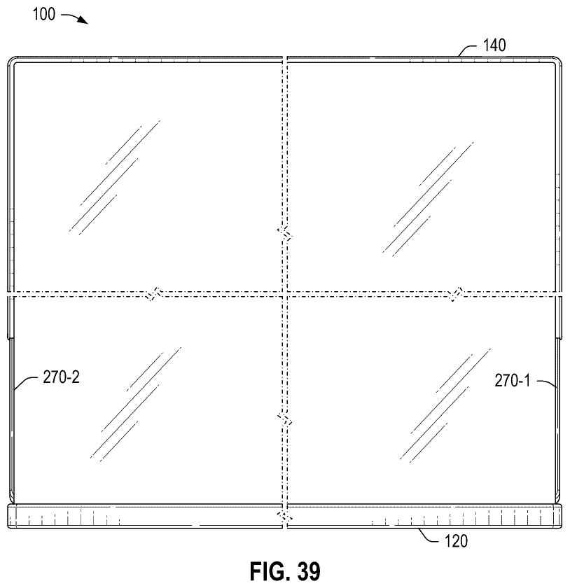

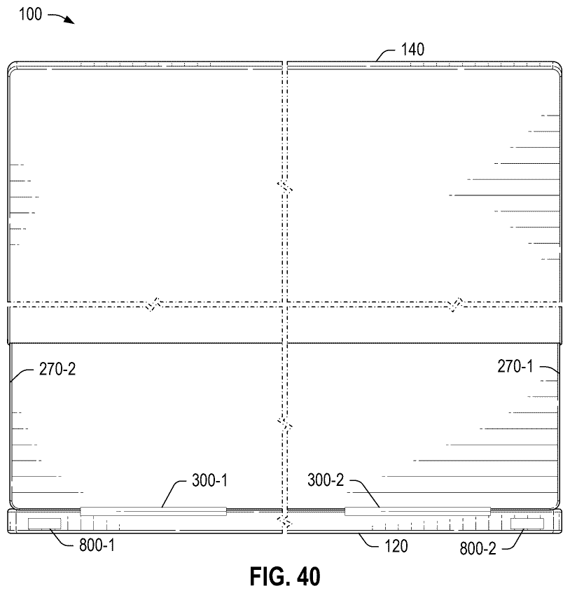

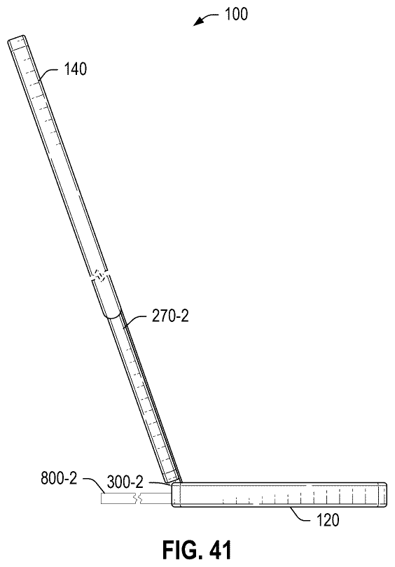

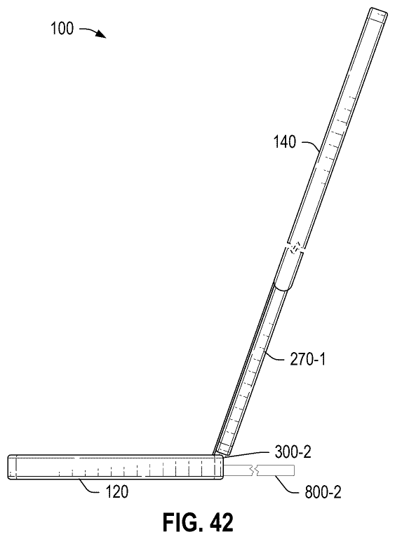

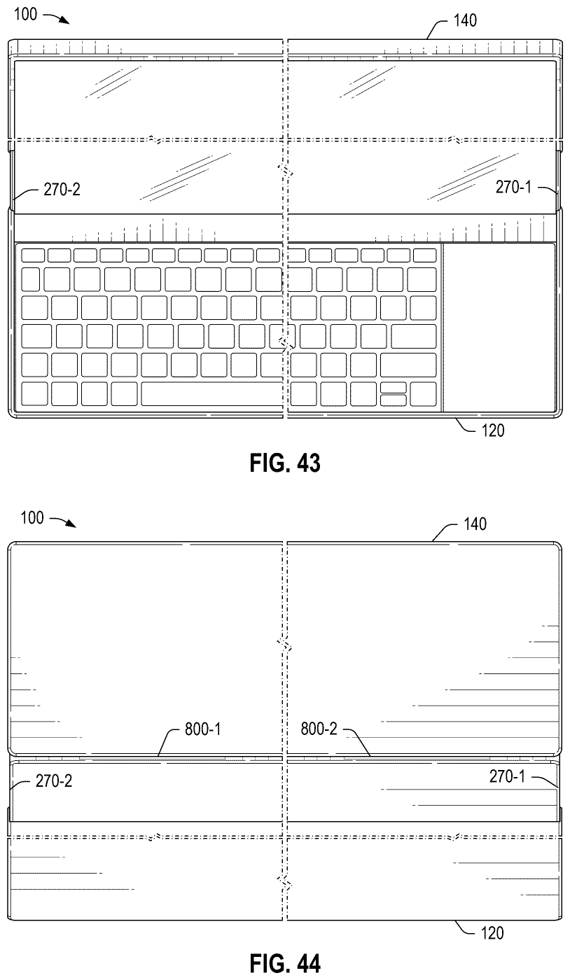

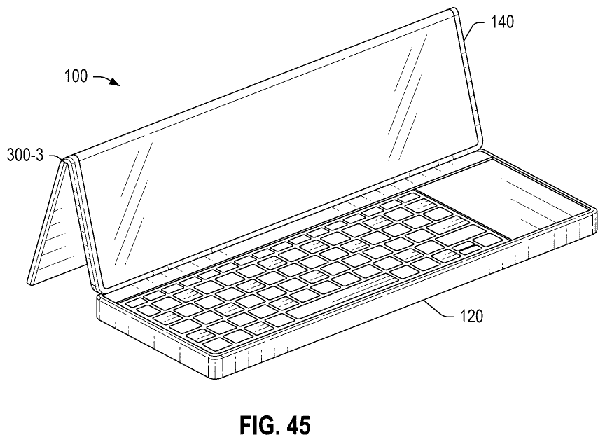

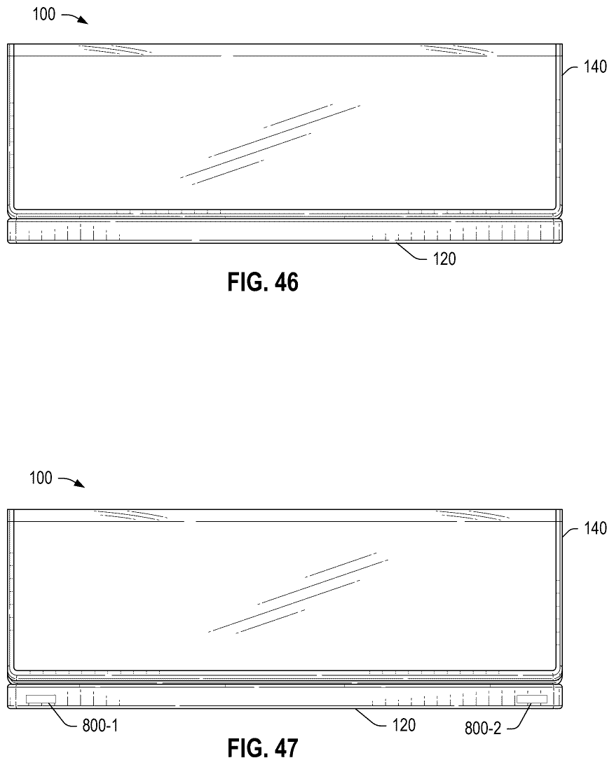

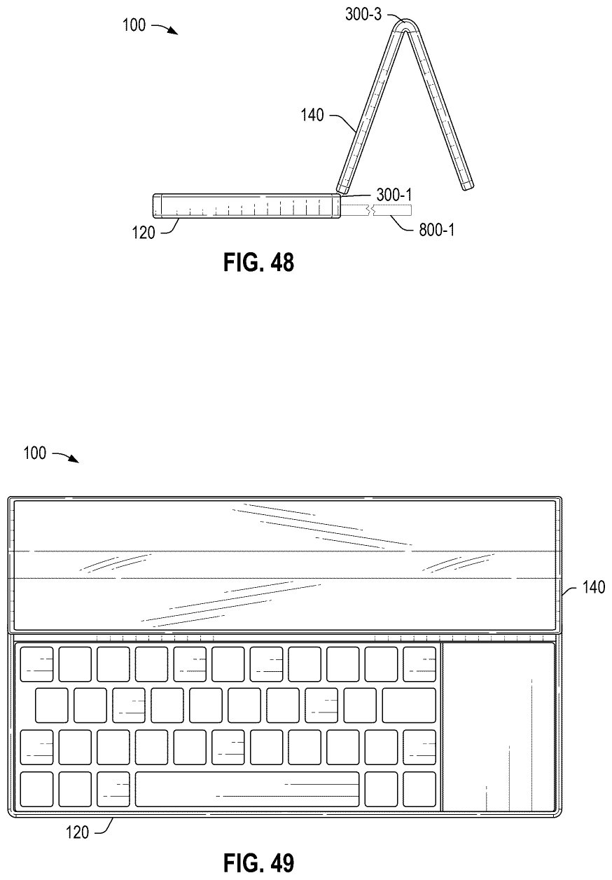

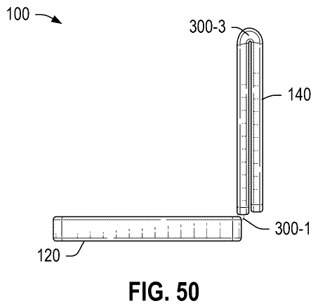

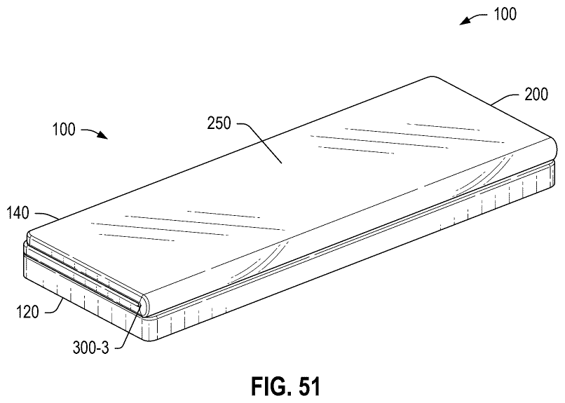

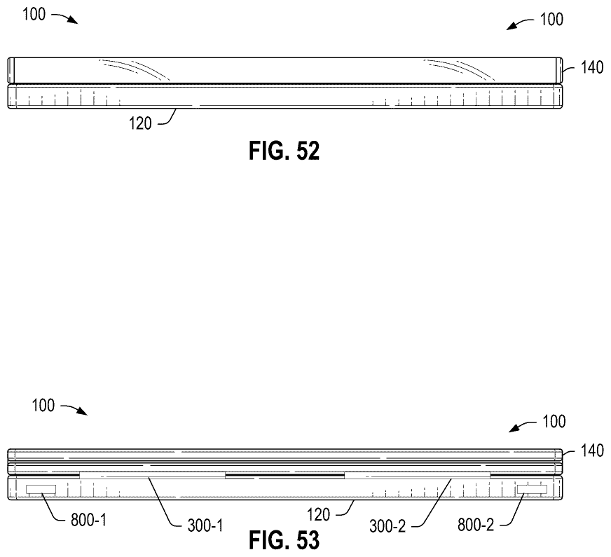

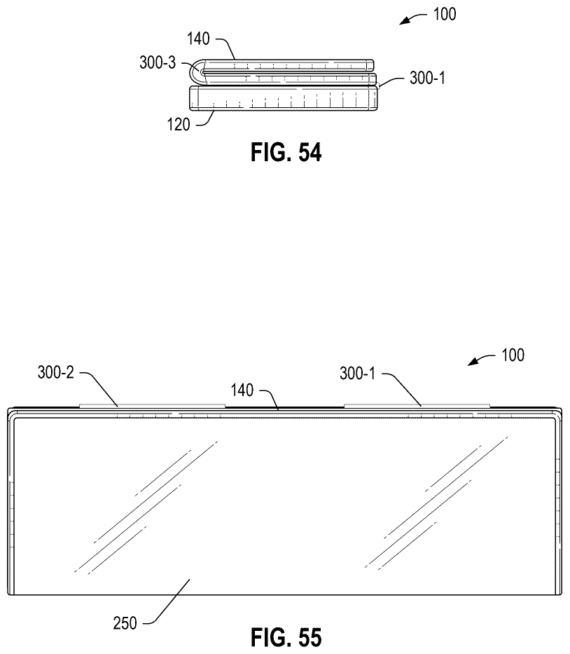

As shown, for example, in FIG. 24, in an open position and in an extended position of an extendable human input device carrier 500, an auxiliary display 700 may be exposed and the extendable human input device carrier 500 may carry a displayable human input device 550 that may display, for example, a displayable keyboard 552.

1. A computing device comprising:
a base housing;
a foldable display;
a display housing for the foldable display wherein the foldable display comprises an open unfolded position, a closed folded position, and an open tented position; and
one or more hinge assemblies that couple the base housing and the display housing.

2. The computing device of claim 1, wherein the foldable display comprises an open folded position.

3. The computing device of claim 2, wherein, in the open folded position, the display housing is positionable at a 90 degree angle with respect to the base housing.

4. The computing device of claim 1, wherein, in the open tented position, the display housing is positionable at an angle greater than 90 degrees with respect to the base housing.

5. The computing device of claim 1, wherein, in the closed folded position, a portion of the foldable display is visible.

6. The computing device of claim 1, wherein the closed folded position is a first closed folded position wherein the foldable display is not visible and further comprising a second closed folded position wherein the foldable display is visible.

7. The computing device of claim 1, comprising an extendable human input device carrier that is extendable from the base housing.

8. The computing device of claim 7, wherein the extendable human input device carrier comprises one or more of a keyboard and a touchpad.

9. The computing device of claim 7, wherein the extendable human input device carrier comprises a display.

10. The computing device of claim 9, wherein the display displays a displayable keyboard as a displayable human input device.

11. The computing device of claim 1, wherein the base housing comprises an auxiliary display.

12. The computing device of claim 11, comprising an extendable human input device carrier that is extendable from the base housing and wherein, in an extended position of the extendable human input device carrier, the auxiliary display is exposed.

13. The computing device of claim 12, wherein the extendable human input device carrier comprises a display.

14. The computing device of claim 1, comprising a processor and memory.

15. The computing device of claim 1, wherein the base housing comprises one or more extensions deployable for stability of the computing device.

16. A computing device comprising:
an extendable human input device carrier;
a base housing for the extendable human input device carrier;
an extendable display that extends between a non-extended size and a fully extended size;
a display housing for the extendable display; and
one or more hinge assemblies that couple the base housing and the display housing.

17. The computing device of claim 16, wherein the base housing comprises an auxiliary display.

18. The computing device of claim 16, wherein, in an extended position of the extendable human input device carrier, the auxiliary display is exposed.

19. The computing device of claim 16, comprising a processor and memory.

20. The computing device of claim 16, wherein the base housing comprises one or more extensions deployable for stability of the computing device.
